(19) United States
(12) Patent Application Publication
(10) Pub. No.: US 2009/0086064 A1
(43) Pub. Date: Apr. 2, 2009

(54) DYNAMIC ADAPTIVE COLOR FILTER ARRAY

(75) Inventor: Jeff Mackey, Boise, ID (US)

Correspondence Address: RatnerPrestia, P.O. BOX 980, VALLEY FORGE, PA, 19482, US

(73) Assignee: MICRON TECHNOLOGY, INC., Boise, ID (US)

(21) Appl. No.: 11/862,650

(22) Filed: Sep. 27, 2007

(51) Int. Cl. H04N 3/15; H04N 5/335

(52) U.S. Cl. 348/273; 348/308; 348/E03.016; 348/E03.017; 348/E03.018; 348/E03.023; 348/E03.028; 348/E05.085; 348/E05.091

(57) ABSTRACT

A microfluidic color filter array, color imager system, and method for dynamic color filtering are disclosed. The microfluidic color filter array includes a network of fluid channels configured to contain fluid solution. The color imager system includes a photodiode array and a microfluidic color filter array disposed over the photodiode array. Fluid solution is supplied through fluid channels of the microfluidic color filter array to provide color filtering when light is received through the fluid channels to a respective photodiode.

### FIELD OF THE INVENTION

The present invention relates generally to color filter arrays. More particularly, the present invention relates to a color filter array for dynamic color filtering.

### BACKGROUND OF THE INVENTION

In some current CMOS imagers, color resolution is achieved by placing a patch of pigment embedded in a resinous material such as a photoresist directly over each individual photodiode. The pigment preferentially passes a specific band of wavelengths in the visible light spectrum so the photodiode detects photons in the given band. An array of such pigments patches (e.g., a color filter array) covers the photodiode array in an alternating pattern. This way, the image to be captured by the image sensor may be resolved into specific color components. Based on the color filter array (CFA) pattern, color components of the original image can be reassembled in a reasonable approximation by interpolation. This works well because the color resolution of the human eye is much less than its luminance (e.g., black and white) resolution. Once the pigment patches are set, however, the color filter array is static and cannot be moved or changed in any way, except with respect to time-related decomposition of its materials.

### BRIEF DESCRIPTION OF THE DRAWING

FIG. 1 is a cross-sectional view of a generic CMOS imager;

FIG. 2 is a perspective view of a color imager according to an embodiment of the invention;

FIG. 3 is a perspective view of an example of multilayered microfluidic color filter arrays;

FIG. 4 is a perspective view of intersecting fluid channels of a microfluidic color filter array;

FIG. 5 is a perspective view of a microfluidic color filter array having criss-cross intersecting fluid channels;

FIG. 6 is a perspective view of a three dimensional microfluidic color filter array;

FIG. 7 is an exploded view of the microfluidic color filter array shown in FIG. 4 according to an aspect of the invention;

FIG. 8 is a schematic view of another embodiment of a microfluidic color filter array;

FIG. 9 is a perspective view of a microfluidic color filter array according to still another embodiment; and

FIG. 10 is a schematic view of a microfluidic color filter array according to according to another aspect;

### DETAILED DESCRIPTION OF THE INVENTION

A device is proposed to provide dynamic coloring filtering such that pigment patterns in a color filter array may be changed or replaced. One example device includes a photodiode array and a microfluidic color filter array positioned over the photodiode array. The microfluidic color filter array includes a network of fluid channels that supply fluid over the photodiodes thereby imparting dynamic color patterning over the photodiodes.

Although the invention is described in terms of a microfluidic color filter array for a CMOS image sensor, it is contemplated that it may be used with other types of photoelectric image sensors (e.g., CCD) or in other applications employing photoelectric devices, for example, as a color filter for an array of emissive devices.

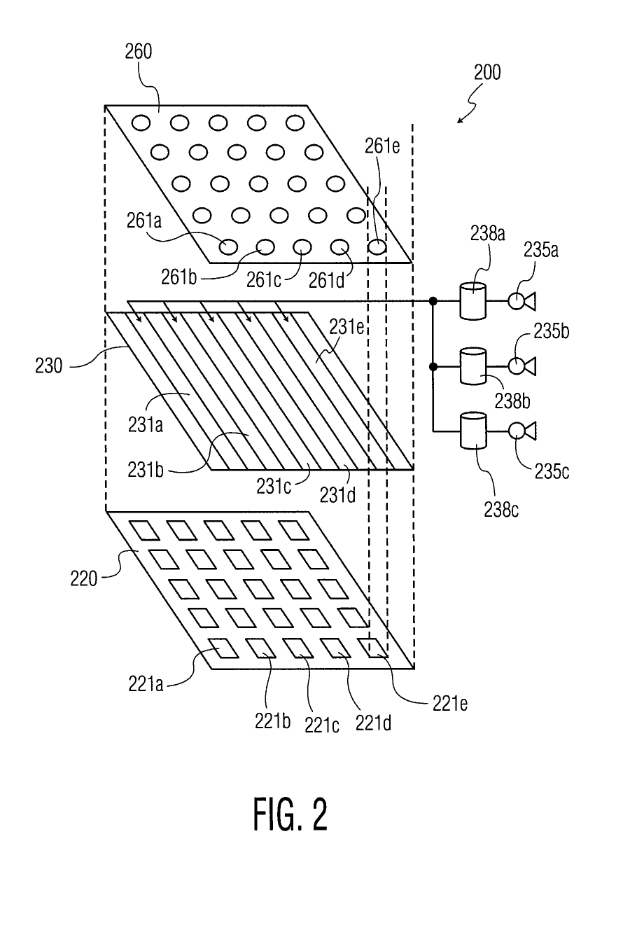

Referring generally to the figures (FIGS. 2-10), in accordance with an example embodiment, a color imager 200 is provided having a photodiode array 220 and a microfluidic color filter array 230, 230a-b, 250a-c, 270. The photodiode array 220 includes a plurality of photodiodes (e.g. 221a-e) arranged in an orthogonal pattern on a common planar support such as a semiconductor wafer substrate. The microfluidic color filter array 230, 230a-b, 250a-b, 270 is disposed over the photodiode array 220 and includes a network of fluid channels 231a-e, 232a-e, 251a-e and/or reservoirs 275 overlapping each photodiode 221a-e. The microfluidic color filter array 240 also includes micropumps 237a-c that are configured to selectively pump fluid solutions through the network of fluid channels. In an embodiment, light passes through a fluid channel 231a-e, 232a-e, 251a-e, vats 237a-d, and/or reservoir 275 positioned over a respective photodiode 221a-e, thereby filtering light which corresponds to the pigment of the fluid solution. Different fluid solutions may be pumped through the fluid channels 231a-e, 232a-e, 251a-e to provide dynamic color filtering of respective photodiodes 221a-e.

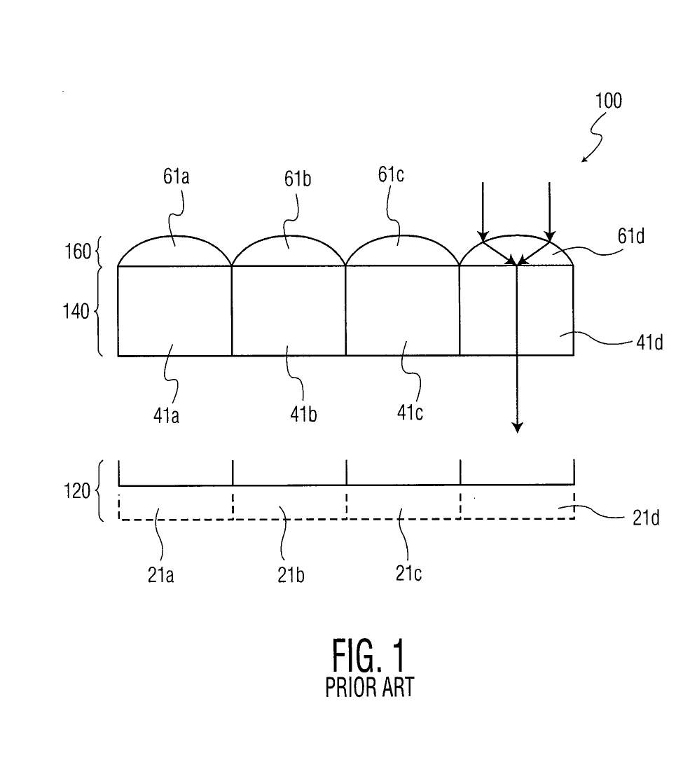

Referring now to the individual figures in detail, FIG. 1 depicts an example embodiment of a generic CMOS imager 100. The illustrated imager 100 includes an array of photodiodes 20a-d on a photodiode array 120. For most imager applications, photodiode array 120 lies in a common plane, such as on a semiconductor substrate. A color filter array 140 is disposed over photodiode array 120 and has an repeating sequence of pigments 41a-d statically embedded in, for example, a photoresist material. Each pigment 41a-d is positioned directly over a respective photodiode 20a-d.

A lens supporting layer 160 may be disposed over color filter array 140. Lens supporting layer 160 includes microlens 61a-d arranged in direct contact with the photoresist material of which color filter array 140 is formed. In an embodiment, light striking microlens 61d is bent inwardly, as indicated by converging arrows through pigment 41d to photodiode 21d. It should be noted that the inward directing of light from microlens 61d to pigment 41d causes light to be received on the central portion of photodiode 21d.

Referring now to FIG. 2, an example microfluidic color filter array 230 of color imager 200 is illustrated. The microfluidic color filter array 230 is suitable for use with a photodiode array 220. Microfluidic color filter array 230 is disposed over photodiode array 220 and photodiode array 220 has a plurality of photodiodes 221a-e arranged in a pattern thereon. Photodiodes 221a-e may be formed on a semiconductor substrate by conventional methods known in the art.

As further shown in FIG. 2, microfluidic color filter array 230 includes a network of fluid channels 231a-e such as microcapillaries that overlap the photodiodes of photodiode array 220 (e.g., photodiodes 221a-e). Standard microfabrication techniques such as lithographic, plasma etching, laser ablation, reactive ion etching (RIE), and chemical etching techniques well-known in the industry are sufficient to create virtually any desired arrangement of fluid channels 231a-e on microfluidic color filter array 230. For example, simple vertical etching on silicon, silicon oxide, silicon nitride, or silicon carbide substrate with an ion beam will create straight channels 231a-e as illustrated in FIG. 2.

Because microfluidic color filter array 230 of imager 200 is microfabricated, substrate materials may be selected based upon their compatibility with known microfabrication techniques. The substrate materials may also be selected for their compatibility with the full range of conditions to which microfluidic color filter array 230 may be exposed, including extremes of pH, temperature, ionic concentration, and application of electric fields. Accordingly, in some aspects, substrate materials may include materials normally associated with the semiconductor industry in which such microfabrication techniques are generally employed, including, e.g., silica based substrates, such as glass, quartz, silicon or polysilicon, as well as other substrate materials, such as gallium arsenide and the like. In the case of semiconductive materials, an insulating coating or layer, e.g., silicon oxide, may be provided over the substrate material, such as in applications where electric fields are to be applied to the microfluidic color filter array 230 or its contents.

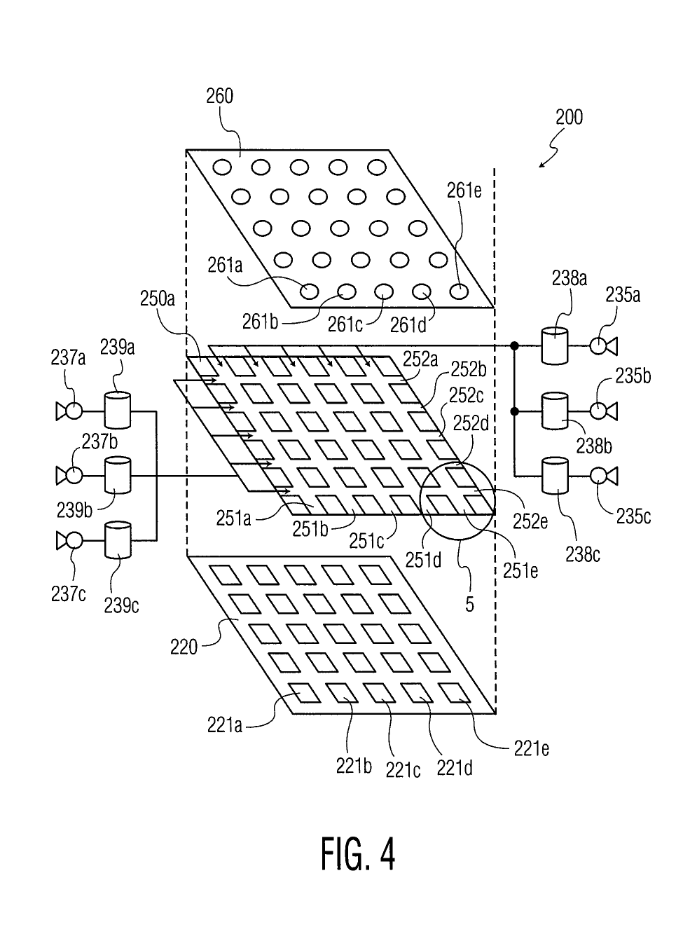

As used herein, the term “microfabrication” or “micro” generally refers to structural elements or features of a device which have at least one fabricated dimension in the range of from about 0.1 μm to about 500 μm. Thus, a device referred to as being microfabricated or micro may include at least one structural element or feature having such a dimension. When used to describe a fluidic element, such as a channel, capillary, or chamber, the terms “micro”, “microfabricated”, or “microfluidic” generally refer to one or more fluid channels, capillaries or chambers which have at least one internal cross-sectional dimension, e.g., depth, width, length, diameter, etc., that is less than 500 μm, and between about 0.1 μm and about 500 μm. Accordingly, microfluidic color filter array 230 typically includes at least one microscale channel 231a-e. In an embodiment (shown in FIG. 4), microfluidic color filter array 230 may include at least two intersecting microscale channels, and may be three or more intersecting channels disposed within a single body structure. Channel intersections may exist in a number of formats, including cross intersections, “T” intersections, or any number of other structures whereby two channels are in fluid communication.

In an embodiment, the structure of microfluidic color filter array 230 may comprise an aggregation of two or more separate layers which, when appropriately mated or joined together, form microfluidic color filter array 230, e.g., containing the channels 231a-e and/or chambers described herein. For example, microfluidic color filter array 230 may comprise a top portion, a bottom portion, and an interior portion, wherein the interior portion substantially defines the channels 231a-e and chambers of microfluidic color filter array 230. For example, typically, the body structure is fabricated from at least two substrate layers that are mated together to define the fluid channel networks of microfluidic color filter array 230, e.g., the interior portion. In an example embodiment, the bottom portion of microfluidic color filter array 230 comprises a solid substrate that is substantially planar in structure, and which has at least one substantially flat upper surface. The interior portion of the bottom portion may include the network of fluid channels formed therein and the substantially flat upper surface of the bottom portion may be coupled to a lens supporting layer.

As illustrated in FIG. 2, the network of fluid channels 231a-e is operably coupled to at least one micropump 235a-c to selectively pump fluid solutions 238a-c through each fluid channel 231a-e. Fluid solutions 238a-c may include, for example, aqueous or non-aqueous solutions containing various color pigments or dyes. In an embodiment, fluid channels 231a-e would service any number of fluids and different dye colors would alternate within a respective fluid channel 231a-e. For example, fluid channel 231a may contain a fluid volume with one color, followed by a volume of the next color. These fluids can be kept from mixing by chemical preparation. For example, a hydrophilic dye solution may be introduced through channel 231a followed by hydrophobic dye solution. In another embodiment, a microchannel within a microchannel such as a double lumen channel 231a may prevent fluid intermix. Thus, when light is transmitted to photodiodes 221a-e, light will pass through fluid solution 238a-c within fluid channels 231a-e and filter colors corresponding to a respective pigment. In one embodiment, some pigments may be left uncolored to act as a pure light enhancing element. It is contemplated that since channels 231a-e are microfabricated, the refractive index of channels 231a-e are substantially the same refractive index of the substrate material despite surface deformity.

Although fluid solutions 238a-c are shown as being supplied to all fluid channels 231a-e, fluid may be delivered to a select fluid channel 231a-e of the fluid network, for example fluid may be provided to a single fluid channel or multiple channels.

In another aspect, when fluid is pumped into a fluid channel 238a-c, fluid previously contained with the fluid channel may be displaced so color may be varied.

In another embodiment, fluid solution 238a-c contains a chemical reagent that alters the color chromophore environment of microfluidic color filter array 230. The chemical reagent, for example, may be an acid or alkali that changes color just as phenolphthalein changes from clear to pink in the presence of a base. In one embodiment, a chemical reactant may pumped into a fluid channel 238a-c, followed by a chemical reagent that reacts with the reactant. Reaction between the two chemicals may alter the color chromophore environment within a respective fluid channel 238a-c. Alternatively, fluid channel 238a-c may be with embedded with ligands that react and change the chromophore environment upon reaction with a chemical reagent or particulates in a colloid solution. For example, in biological systems, the binding of specific molecules to a ligand may cause the bound complex to fluoresce with various color pigments. Although simple acid and base solutions have been described, other chemical reactants/reagents may be supplied through the fluid network to alter color pigment within fluid channels 231a-e.

In a response to extreme heat or cold, colloid-based fluids may also be used so that fluid within microfluidic color filter array 230 prevents damage to fluid channels 231a-e. Colloid-based fluids include solid particles such as proteins or glycols suspended in the fluid solution to alter the properties of the fluid. For example, the freezing point of fluid solution 238a-c is easily suppressed by the addition of small amounts of appropriate proteins, as used in creating frost-resistant crops. Other suitable hydrophilic colloids can be suspended in fluid solution 238a-c such as protein derivatives, cellulose derivatives, and polysaccharides to provide thermal hysteresis. In yet another embodiment, altering the ionic strength and polarity of the fluid may also change thermal property.

As further illustrated in FIG. 2, color imager 200 may also include a lens supporting layer 260 disposed over microfluidic color filter array 230. The lens supporting layer 260 has a plurality of microlens 261a-e arranged thereon in a pattern that corresponds to the photodiode pattern on photodiode array 220. Microlens 261a-e focus light into microfluidic color filter array 230 and photodiode array 220, such that light is filtered through fluid channels 231a-e, thereby filtering colors that corresponds to the pigment of fluid solution 238a-c.

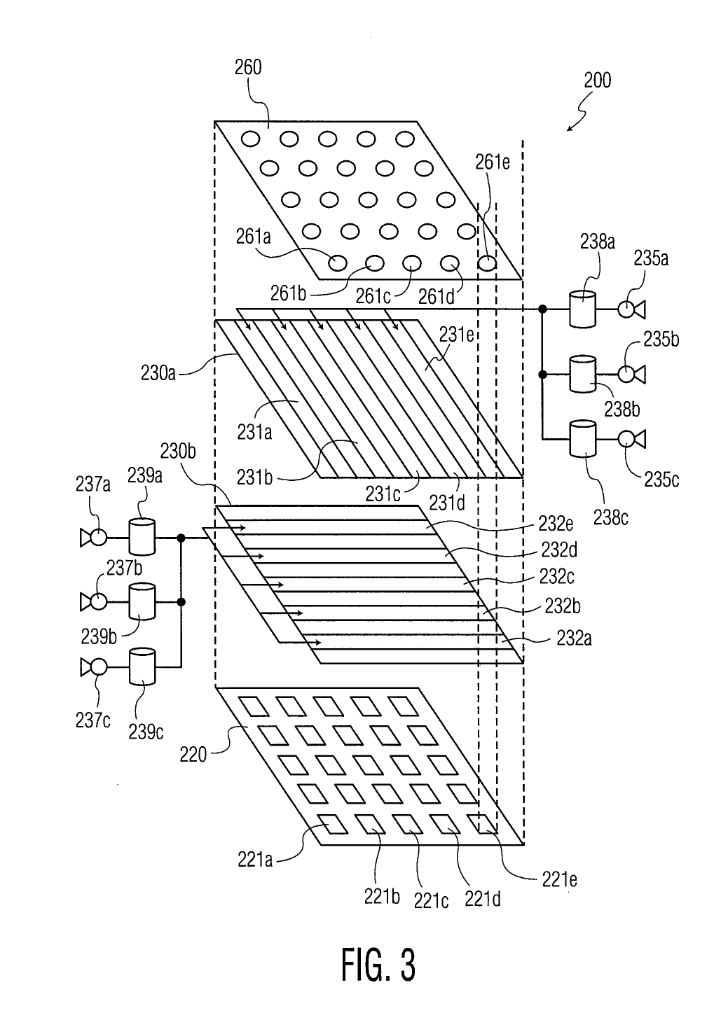

Referring now to FIG. 3, another example color imager 200 is illustrated. Combination filters may be obtained by using multiple layers of microfluidic color filter arrays 230a, 230b so that fluid channels 231a-e, 232a-e overlap over photodiodes 221a-e. Regions of overlap provide different color combinations over a respective photodiode 221a-e and may also provide faster color switching over photodiodes 221a-e. For example, fluid solutions 239a-c of array 230b may contain pigments different than fluid solutions 238a-c of array 230a and by varying the pigments within respective fluid channels 231a-e, 232a-e, color combinations beyond the traditional green, blue, and red colors may be obtained over the regions of overlap. In another embodiment, fluids which block transmission of red, green, and blue colors may also be overlapped. For example, blocking the transmission of red and green may produce a blue filter and blocking the transmission of red and blue may produce a green filter. In yet another embodiment, blocking the transmission of blue and green may produce a red filter.

To accommodate faster color switching, fluid flow rate through fluid channels 231a-e, 232a-e maybe controlled by micropumps 235a-c, 237a-c. Example micropumps may include the used of a pneumatic manifold such as miniature flexible diaphragms. In an embodiment, micropumps 235a-c may include piezoelectric vibrator elements mounted upon the interior or exterior surface of microfluidic color filter color filter array 230 whereby vibration of micropumps 235a-c actuates fluid flow through channels 232a-e.

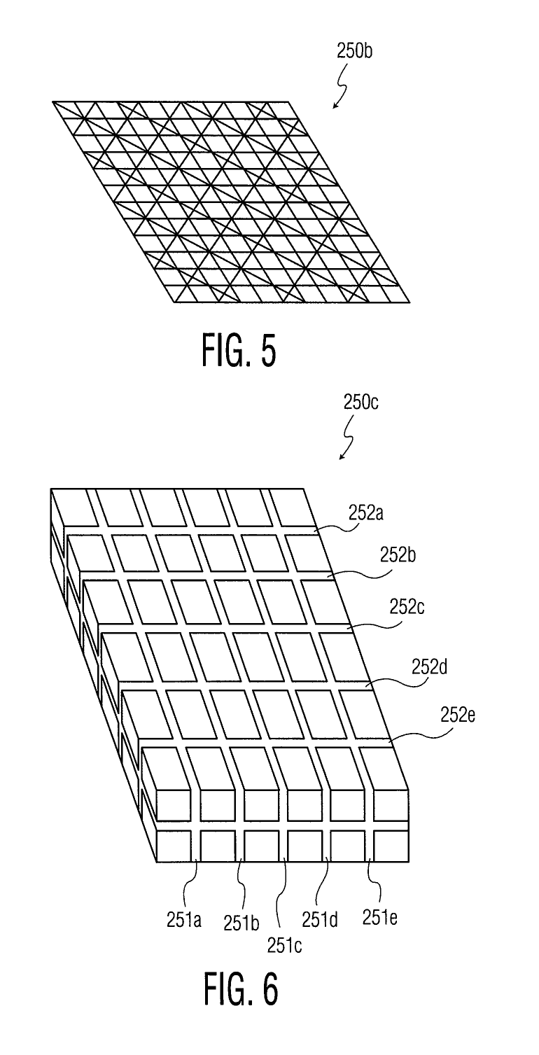

Referring now to FIG. 4, an example color imager 200 according to another aspect of the invention is illustrated. Microfluidic array 250a includes a network of fluid channels 251a-e, 252a-e that intersect each other at intersection points in a two-dimensional grid. Although fluid channels 251a-e, 252a-e are shown to intersect at 90° angles, more sophisticated networks of fluid channels 251a-e, 252a-e may be implemented, with the only limiting factor being spatial considerations of microfluidic color filter array 250a. For example, as shown in FIG. 5, microfluidic color filter array 250b may be densely populated with fluid channels arranged in a criss-cross pattern at various intersection angles. Alternatively, fluid channels 251a-e, 252a-e may be arranged in a three-dimensional grid 250c, shown in FIG. 6, having substantially vertical and horizontal fluid channels such as a “plumbing system,” with the network of fluid channels 251a-e, 252a-e operably coupled to each other at intersection points in the three-dimensional grid.

As illustrated in FIG. 4, fluid channels 251a-e, 252a-e are operably coupled to each other at intersection points such that fluid solutions 238a-c, 239a-c may be directed over specific photodiodes 221a-e. Simple electrokinetic fluid flow across intersection points could be accomplished by applying voltage gradients across specific points along the length of channels 251a-e, 252a-e, thereby altering the diffusive property of fluid solutions 238a-c, 239a-c. As used herein, “electrokinetic fluid flow” include systems which transport and direct materials within an interconnected channel and/or chamber containing structure, through the application of electrical fields to the materials, thereby causing material movement through and among the channel and/or chambers, i.e., cations will move toward the negative electrode, while anions will move toward the positive electrode.

Such electrokinetic material transport and direction systems include those systems that rely upon the electrophoretic mobility of charged species within the electric field applied to the structure. Such systems are more particularly referred to as electrophoretic material transport systems. Other electrokinetic material direction and transport systems rely upon the electroosmotic flow of fluid and material within a channel or chamber structure which results from the application of an electric field across such structures. In brief, when a fluid is placed into a channel which has a surface bearing charged functional groups, e.g., hydroxyl groups in etched glass channels or glass microcapillaries, those groups can ionize. In the case of hydroxyl functional groups, this ionization, e.g., at neutral pH, results in the release of protons from the surface and into the fluid, creating a concentration of protons at near the fluid/surface interface, or a positively charged sheath surrounding the bulk fluid in the channel. Application of a voltage gradient across the length of the channel, will cause the proton sheath to move in the direction of the voltage drop, i.e., toward the negative electrode. Accordingly, fluid solutions 238a-c, 239a-c may flow through or bypass specific intersection points in the grid without fluid intermix.

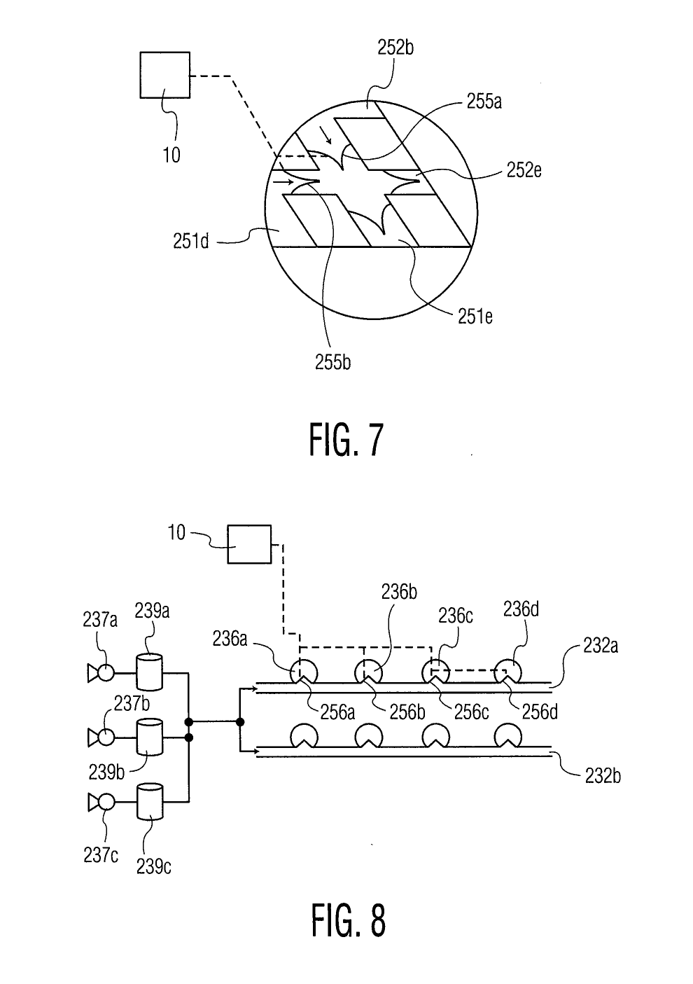

In another embodiment, as shown in FIG. 7, fluid direction may be accomplished through the incorporation of microfabricated valves 255 which restrict fluid flow in a controllable manner. Passive valves 255a-b similar to baffles of the circulatory system may be used to direct fluid flow (designated by arrows) in one direction, but restrict flow in the opposite direction. For example, the passive valves may be opened or closed based on fluid pressure differentials from regions of high pressure to low pressure. Furthermore, active transport valves may be used to open and close gated valves in response to electrical signals and/or field potentials of a piezoelectric cell or microcontroller 10. In yet another embodiment shown in FIG. 8, microfluidic color filter array may include vats 236a-d that may be operably connected to valves 256a-d. Microcontroller 10 may be electrically coupled valves 256a-d to selectively open or close a valve 256a-d of a particular vat 236a-d. Thus, when fluid flows through fluid channel 232a, fluid may flow into or bypass certain vats 236a-d, to selectively fill each vat 236a-d with a particular color. Although, a microcontroller system has been described to control directional fluid flow, other devices may be used to control directional flow through the fluid channels. For example, directional fluid flow may be controlled by a color imager itself, for example during a pixel/reset operation to impart a negative or positive charge to a specific pixel, thereby controlling directional fluid flow.

According to another embodiment, vats 236a-d may be inflatable such that when vats 236a-d are filled, vats 236a-d may form shapes that resemble microlens 61a-d (shown in FIG. 1). Thus, vat 236a may combine features of a microlens and color filter to direct light to photodiodes and provide dynamic color filtering.

Referring now to FIG. 9, another microfluidic color filter array 270 according to an embodiment of the invention is illustrated. Microfluidic array 270 is disposed over photodiode array (not shown) and includes a network of fluid channels 271a-e operably connected to reservoirs 275. Each reservoir 275 is positioned over a photodiode on the photodiode array such that when light is transmitted to the plurality of photodiodes through reservoirs 275, dynamic color filtering is provided.

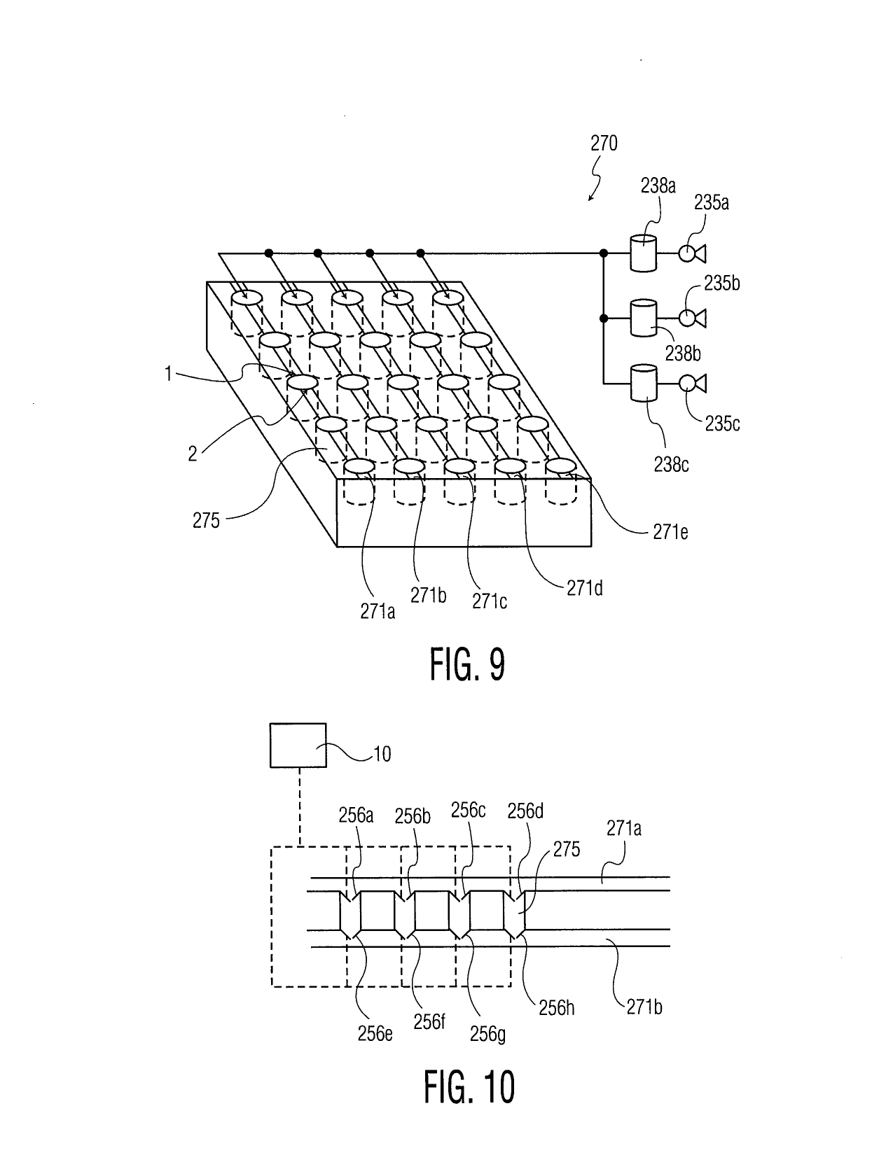

Each reservoir 275 comprises at least one fluid channel inlet 1 and outlet 2 to selectively supply and empty fluid solution 238a-c to and from a respective reservoir 275. Fluid solution 238a-c may be supplied, for example, via micropumps 235a-b. In an embodiment, before introducing a new fluid solution 238a-c into a reservoir 275, solvents may be used to flush the reservoir 275 and minimize mixing of fluid solution 238a-c. In another embodiment shown in FIG. 10, reservoirs 275 may be operably coupled to valves that are responsive to a control signal (such as a microcontroller 10 or other device) to open or close the valves 256a-h to selectively fill or drain a respective reservoir 275.

Accordingly, a microfluidic color filter array is provided, according to embodiments of the invention, to provide dynamic filtering by the optical properties of fluid solution supplied to the array. An advantage that may be afforded by this technology is the liberation of dual green pixels of traditional static color filter arrays. In traditional color filter arrays, color pixels come in sets of four, but color decomposition uses a basis of three color (usually red, green, and blue). The “redundant” color is usually green. Thus, in embodiments of the invention, each pixel may filter a different color based on where the pigment is at any given moment in the microfluidic color filter array. Furthermore, a microfluidic color filter array offers a means to fill a light channel such as an optical fiber, thereby solving the problem of how to incorporate a color filter into a light pipe. In light emissive devices, the microfluidic color filter array may also function as a heat exchanger, thereby cooling the imager.

According to embodiments of the invention, example color imagers for dynamic color filtering are provided. The color imager includes a photodiode array and a microfluidic color filter array disposed over the photodiode array. The photodiode array has a plurality of photodiodes arranged in a pattern and the microfluidic color filter array has a network of fluid channels overlapping each photodiode. The network of fluid channels is operably coupled to at least one micropump to selectively pump a fluid solution through each fluid channel. When light is transmitted by the plurality of photodiodes through the network of fluid channels, dynamic color filtering is provided on the color imager.

An example microfluidic color imager having is disposed over the photodiode array and includes a network of fluid channels and reservoirs. Each reservoir is positioned over a photodiode and the network of fluid channels is operably coupled to at least one micropump to selectively pump a fluid solution through a fluid channel and into a respective reservoir. Thus, when light is transmitted by the plurality of photodiodes through the reservoirs, dynamic color filtering may be provided on the color imager.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A microfluidic color filter array comprising:
a network of fluid channels configured to contain a fluid solution and to provide color filtering when light is transmitted through the network of fluid channels;
at least one micropump operably coupled to the network of fluid channels, the at least one micropump configured to selectively pump the fluid solution through each fluid channel; and
at least one fluid source operably coupled to the at least one micropump, the at least one fluid source configured to supply the fluid solution to the network of fluid channels when pumped by the at least one micropump.

2. The microfluidic color filter array of claim 1, wherein the at least one micropump includes a piezoelectric vibrator element.

3. The microfluidic color filter array of claim 2, wherein the at least one micropump is electrically coupled to a microcontroller, the microcontroller configured to transmit an electrical signal to each micropump and thereby selectively control pumping of fluid solution through each fluid channel.

4. The microfluidic color filter array of claim 3, wherein the fluid solution is selected from the at least one fluid source that contains a non-aqueous solution having a color pigment.

5. The microfluidic color filter array of claim 4, wherein the non-aqueous solution comprises a colloid solution.

6. The microfluidic color filter array of claim 3, wherein the fluid solution is selected from the at least one fluid source that contains an aqueous solution having a color pigment.

7. The microfluidic color filter array of claim 6, wherein the aqueous solution comprises a hydrophobic solution.

8. The microfluidic color filter array of claim 6, wherein the aqueous solution comprises a hydrophilic solution.

9. The microfluidic color filter array of claim 6, wherein the aqueous solution comprises a colloid solution.

10. The microfluidic color filter array of claim 1, wherein the microfluidic color filter array is arranged in a two-dimensional grid having respective rows and columns of fluid channels, each row of fluid channels being operably coupled to each column of fluid channels at respective intersection points.

11. The microfluidic color filter array of claim 10, wherein the network of fluid channels includes passive baffles that each direct fluid flow in a single direction through a respective intersection point.

12. The microfluidic color filter array of claim 10, wherein the network of fluid channels includes active valves that are each responsive to a respective control signal to direct fluid flow through a respective intersection point.

13. The microfluidic color filter array of claim 1, wherein the network of fluid channels is arranged in a three-dimensional grid having substantially vertical and horizontal fluid channels, each horizontal fluid channel configured to operably couple to a vertical fluid channel at a respective intersection point.

14. The microfluidic color filter array of claim 1, further comprising vats, each vat operably coupled to at least one of the fluid channels and to a respective valve that selectively supplies the fluid solution into the respective vat responsive to a control signal.

15. The microfluidic color filter array of claim 14, wherein the vats are inflatable and, when inflated form a lens structure.

16. The microfluidic color filter array of claim 1, further comprising reservoirs, each reservoir including at least one fluid channel inlet coupled to the fluid channel and configured to selectively supply the fluid solution into a respective reservoir.

17. The microfluidic color filter array of claim 16, wherein each reservoir comprises a fluid channel outlet coupled to the fluid channel and configured to empty the fluid solution from a respective reservoir.

18. The microfluidic color filter array of claim 16, wherein each reservoir is operably coupled to at least one valve that selectively supplies or removes the fluid solution into or out of the respective reservoir responsive to a control signal.

19. A color imager system comprising:
a photoelectric array including a plurality of photoelectric devices; and
a microfluidic color filter array disposed over the photoelectric array, the microfluidic array comprising a network of fluid channels operably coupled to at least one micropump and at least one fluid source, the at least one micropump configured to pump fluid solution from the at least one fluid source through the network of fluid channels, each fluid channel positioned over at least one photoelectric element and configured to contain a fluid solution and provide color filtering when light is transmitted through the network of fluid channels to the plurality of photoelectric elements.

20. The color imager system of claim 19, further comprising a lens supporting layer disposed over the microfluidic color filter array, the lens supporting layer having a plurality of microlens arranged over the network of fluid channels.

21. A method for establishing dynamic color filtering of a color imager having a plurality of photodiodes, the method comprising the steps of:
alternating volumes of respectively different color filter fluid solutions through fluid channels of a microfluidic color filter array such that each volume of color filter fluid solution corresponds to a respective photodiode in the color imager; and
controlling directional flow of color filter fluid solution through the fluid channels to position each volume of color filter fluid solution adjacent a respective photodiode to provide a dynamic color scheme through the microfluidic color filter array.

22. The method of claim 21, comprising the step of alternating volumes of hydrophobic and/or hydrophilic color filter fluid solution through the fluid channels such that intermix between the volumes of hydrophobic and/or hydrophilic color filter fluid solution is minimized.

23. The method of claim 21 comprising the step of supplying a colloid color filter solution through the fluid channels, the fluid channels having ligands coupled thereto and configured to operably bind to particulates in the colloid color filter solution, thereby altering a chromophore environment of the microfluidic color filter array.

24. The method of claim 21, wherein controlling directional flow of color filter fluid solution comprises controlling active valves coupled to the fluid channels thereby directing color filter fluid solution to a fluid channel positioned adjacent to a respective photodiode.

25. The method of claim 21, wherein controlling directional flow of color filter fluid solution comprises opening or closing valves coupled to the fluid channels responsive to a control signal thereby directing color filter fluid solution to a fluid channel positioned adjacent to a respective photodiode.
